(19) United States
(12) Patent Application Publication
(10) Pub. No.: US 2006/0073311 A1
(43) Pub. Date: Apr. 6, 2006

(54) Apparatus and method for composite tape profile cutting

(75) Inventor: Merrill W. Hogg, Maple Valley, WA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company

(21) Appl. No.: 11/088,288

(22) Filed: Mar. 24, 2005

Related U.S. Application Data
(60) Provisional application No. 60/615,895, filed on Oct. 5, 2004.

(51) Int. Cl. B32B 1/00

(52) U.S. Cl. 428/174

(57) ABSTRACT

A composite member and an associated method and apparatus for forming the composite member are provided. The composite member is formed of a plurality of elongate tapes. Side edges of some or all of the tapes can be trimmed to reduce or eliminate the occurrence of laps or gaps between the adjacent tapes.

### CROSS-REFERENCES TO RELATED APPLICATIONS

This application is a continuation-in-part of copending U.S. patent application Ser. No. 60/615,895, filed on Oct. 5, 2004, which is hereby incorporated herein in its entirety by reference.

### BACKGROUND OF THE INVENTION

1) Field of the Invention

The present invention relates to the manufacture of composite structures and, more specifically, to an apparatus and associated method for trimming elongate tapes and disposing the tapes in a desired configuration to form the composite structures.

2) Description of Related Art

Composite members are typically formed of a reinforcement material that is disposed in a matrix material. For example, the reinforcement material can be a fibrous material such as graphite, and the matrix material can be a resinous polymer material. According to one conventional manufacturing method, the composite material is disposed in the desired shape of the composite member by laying a plurality of elongate composite tapes to progressively build the layers of the member. An automated operation for forming the composite member can begin by using a tape layup machine to dispose a first layer of tapes onto a mandrel that defines the shape of the composite member. The machine includes a roll or other supply of the tape, which is dispensed onto the mandrel with a tape placement head that guides the tapes onto the mandrel in the desired configuration. That is, the tape placement head provides relative movement between the mandrel and the head so that the head moves over the surface of the mandrel. The head usually makes repeated passes over the mandrel in a defined pattern until the mandrel is entirely covered, and additional layers of the tape are built up by continued passes of the head over the surface. A compaction roller presses the tape against the mandrel or the previously disposed layers of tape to facilitate adhesion of the multiple layers of the tape.

This conventional layup machine can accurately place the tapes, and the automated process can increase the speed at which the composite members can be formed. In addition, the layup machine is typically able to lay the tapes in a variety of configurations corresponding to the surface of a select mandrel to thereby form the composite member to the desired shape. However, if the surface of the mandrel defines a complex contour, the tapes disposed by the machine may define laps or gaps. That is, the adjacent tapes of each layer may define overlapping portions (“laps”) or spaces between the tapes (“gaps”). Laps and gaps can decrease the strength of the resulting composite member. In some cases, the resulting decrease in strength due to the laps and gaps may be sufficiently high as to preclude the use of the layup machine for forming the member.

Therefore, an apparatus and method is needed for disposing tapes to define complex configurations while reducing or minimizing the laps and/or gaps defined by adjacent tapes.

### SUMMARY OF THE INVENTION

The present invention provides a composite member and an associated method and apparatus for forming the member. The composite member is formed of a plurality of elongate tapes, some or all of which can be trimmed to reduce or eliminate the occurrence of laps or gaps between the adjacent tapes.

The method includes providing a contour surface corresponding in shape to a desired contour of the composite member and disposing a plurality of the elongate tapes in a substantially parallel configuration on the contour surface. A first side edge of a first one of the tapes is trimmed to a predetermined configuration that is nonparallel relative to a second side edge of the first tape opposite the first side edge. Thus, the first side edge is made to correspond to a configuration of a second one of the tapes when the first and second tapes are disposed adjacently on the contour surface. One or both of the side edges of some or all of the tapes can be trimmed, and each can be trimmed to a nonlinear and/or nonparallel configuration relative to the opposite edge of the same tape, such as a continuous arc. Each edge can be trimmed with a blade edge, such as the edge of an ultrasonically reciprocating blade. Each tape typically includes a plurality of reinforcement members disposed in a matrix material, and some of the reinforcement members of the tape can be cut during trimming.

The tape can be trimmed upon detection of an edge of an adjacent tape. Alternatively, the configuration of each tape can be determined before disposing the tapes. For example, the configuration of each tape can be determined by mathematically modeling the configuration of the tapes according to a predetermined product definition that corresponds to the finished shape (and typically also corresponds to the contour of the mandrel). Further, each tape can be stored after being trimmed and before being disposed, e.g., by delivering the tape to a supply device, which can store the tape and subsequently dispense the tape. In either case, the tapes can be disposed with substantially no laps or gaps.

The present invention also provides a composite member defining a contour. The member includes a plurality of elongate tapes that are disposed in a substantially parallel configuration to define a contour surface. Each tape includes a plurality of reinforcement members disposed in a matrix material and defines first and second side edges. A first one of the tapes defines a first side edge that is trimmed to a nonparallel configuration relative to an opposite edge of the first tape, e.g., a nonlinear configuration such as a continuous arc. Thus, the first side edge corresponds to a configuration of a second one of the tapes disposed adjacent to the first edge of the first tape. The first edge of the first tape can be disposed proximate the second tape with substantially no lap or gap. Any number of the tapes can have side edges that are trimmed. One or more of the reinforcement members of each tape can be noncontinuous between the ends of the tape.

The present invention also provides an apparatus for disposing elongate tapes during formation of a composite member. The apparatus includes a tape dispenser configured to store at least one elongate tape so that the tape can be dispensed. A tape trimmer is adapted to receive the tape from the dispenser and trim a first side edge of the tape. A controller is configured to control the tape trimmer and thereby trim the tape to define a profile corresponding to an adjacent tape of the composite member. The apparatus can also include a tape placement head that is configured to dispose the tape on a contour surface in a shape corresponding to a desired contour of the composite member. In addition, or alternative, the apparatus can include a roll or spool configured to receive the trimmed tape from the tape trimmer. In either case, the tape trimmer can be configured to trim the first side edge, and optionally a second side edge of the tape, to a nonlinear configuration. In particular, the tape trimmer can be an ultrasonically reciprocable blade. Further, the apparatus can include a detector for detecting a contour defined by the composite member and communicating with the controller so that the controller is configured to trim the tape to correspond to the contour, and/or a memory configured to store data for trimming the tape according to a predetermined configuration.

### BRIEF DESCRIPTION OF THE SEVERAL VIEWS OF THE DRAWINGS

The accompanying drawings illustrate preferred and exemplary embodiments and are not necessarily drawn to scale.

FIG. 1 is an elevation view schematically illustrating an apparatus for disposing an elongate tape during formation of a composite member.

FIG. 2 is a perspective view illustrating a composite member.

FIG. 3 is a perspective view illustrating first and second adjacent elongate tapes in an untrimmed configuration.

FIG. 4 is a perspective view illustrating the first and second adjacent elongate tapes of FIG. 3 with the first tape trimmed to a configuration corresponding to the second tape.

FIGS. 5 and 6 are plan views of elongate tapes with trimmed first sides.

FIGS. 7-9 are plan views of elongate tapes having first and second sides trimmed.

FIG. 10 is a plan view schematically illustrating the apparatus of FIG. 1 during formation of a composite member.

FIG. 11 is an elevation view schematically illustrating a trimming operation.

FIG. 12 is a plan view schematically illustrating the trimming operation of FIG. 11.

### DETAILED DESCRIPTION OF THE INVENTION

The present invention now will be described more fully with reference to the accompanying drawings, in which some, but not all embodiments of the invention are shown. This invention may be embodied in many different forms and should not be construed as limited to the embodiments set forth. Like numbers refer to like elements throughout.

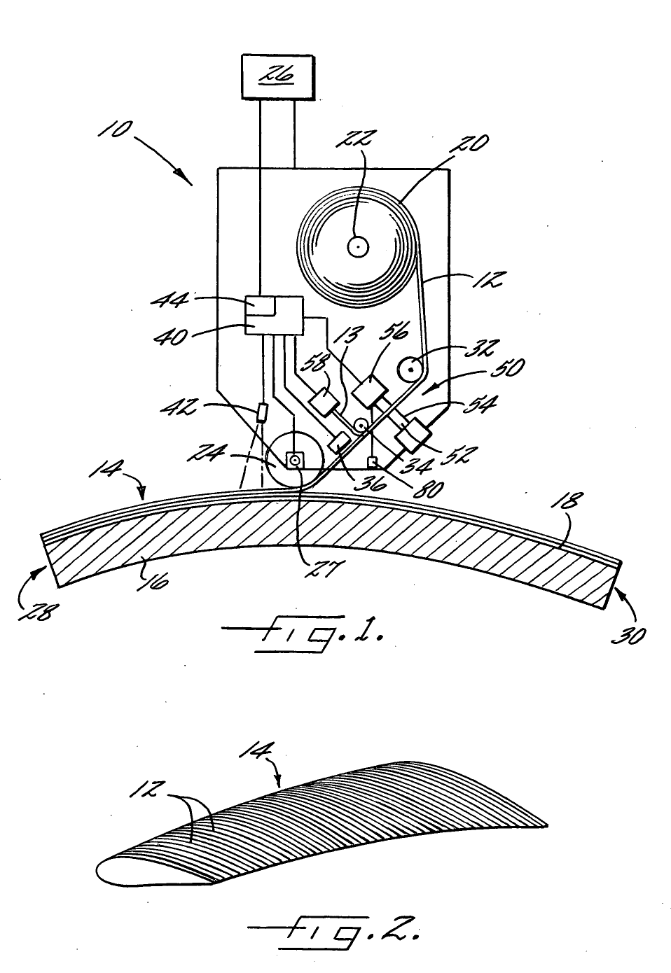

FIG. 1 schematically illustrates an apparatus 10 for disposing an elongate tape 12 during formation of a composite member 14. The apparatus 10 can be used to form composite members 14 of a variety of materials and having various configurations. In particular, the apparatus 10 can be used to dispose one or more elongate tape 12 (or “tow”) that includes a reinforcement material disposed in a matrix material. Typically, the reinforcement material is a plurality of fibrous members such as fibers, strands, braids, woven or nonwoven mats, and the like of materials such as fiberglass, metal, minerals, conductive or nonconductive graphite or carbon, nylon, aramids such as Kevlar®, a registered trademark of E. I. du Pont de Nemours and Company, and the like. Each tape 12 typically includes the matrix material, in which the reinforcement members are disposed. In some cases, however, the tapes 12 can be formed without the matrix material, and the matrix material can be disposed separately. In any case, the matrix material can include various materials such as thermoplastic or thermoset polymeric resins. Exemplary thermosetting resins include allyls, alkyd polyesters, bismaleimides (BMI), epoxies, phenolic resins, polyesters, polyurethanes (PUR), polyurea-formaldehyde, cyanate ester, and vinyl ester resin. Exemplary thermoplastic resins include liquid-crystal polymers (LCP); fluoroplastics, including polytetrafluoroethylene (PTFE), fluorinated ethylene propylene (FEP), perfluoroalkoxy resin (PFA), polychlorotrifluoroethylene (PCTFE), and polytetrafluoroethylene-perfluoromethylvinylether (MFA); ketone-based resins, including polyetheretherketone (PEEK™, a trademark of Victrex PLC Corporation, Thorntons Cleveleys Lancashire, UK); polyamides such as nylon-6/6, 30% glass fiber; polyethersulfones (PES); polyamideimides (PAI), polyethylenes (PE); polyester thermoplastics, including polybutylene terephthalate (PBT), polyethylene terephthalate (PET), and poly(phenylene terephthalates); polysulfones (PSU); poly(phenylene sulfides) (PPS). For example, the resin can be Toray® 3900 series resin from Toray Industries Inc. of Tokyo, Japan.

The tapes 12 can be disposed to define a desired configuration of the composite member 14. In particular, the tapes 12 can be disposed to form members of various sizes and shapes. For example, the composite member 14 illustrated in FIG. 2 is a wing for an aircraft. In other embodiments, the composite members 14 can be used as other airfoils, aircraft body panels, other members for aerospace vehicles and structures, structural members of automobiles, marine vehicles or other vehicles, and the like. In some cases, the composite member 14 can define a complex geometry, e.g., one or more contours that are curved about multiple axes, define bends, apertures, or other irregular shapes, and the like.

The apparatus 10 can generally define a tape placement head that is used to dispose the elongate tape 12 in a configuration corresponding to the desired shape of the composite member 14. For example, as illustrated in FIG. 1, the apparatus 10 can dispose the elongate tape 12 onto a mandrel 16, i.e., a tool with a contour surface 18 that is then imparted to the tape 12 and, hence, the composite member 14. Various types of mandrels can be used, and the mandrel 16 can define a variety of contours. In particular, the surface 18 of the mandrel 16 can define a complex contour on which it would be difficult or impossible to dispose rectangular tapes without laps or gaps occurring between the adjacent tapes. Also, while the tape 12 can be disposed “on” the mandrel 16, a first layer of the tape 12 may be disposed directly on the mandrel 16 and subsequent layers may be disposed on the prior layers.

The apparatus 10 includes a supply of one or more elongate tape 12, which is dispensed and disposed onto the contour surface 18. For example, the tape 12 can be supplied in a dispenser, such as a roll 20 that is supported on a spool 22 mounted in the apparatus 10. In some cases, the dispenser can include multiple rolls or other supply devices that provide multiple tapes 12 to be simultaneously disposed on the mandrel 16. Alternatively, a single tape 12 can be disposed in one or more portions. For example, a single tape 12 can be severed into multiple portions that are disposed successively on the mandrel 16, or the single tape 12 can be disposed continuously on the mandrel 16 as a single piece without being severed. That is, the “plurality of tapes” or “multiple tapes” can be disposed as a single piece of tape that defines a plurality of adjacent elongate portions.

The spool 22 supporting the roll 20 in FIG. 1 is rotatably mounted so that the tape 12 can be dispensed. The tape 12 is supplied from the roll 20 to a placement guide that controls the placement of the tape 12 on the mandrel 16. The placement guide can be a roller 24, as shown, that is rotatably mounted so that the apparatus 10 can be moved over the surface 18 of the mandrel 16 with the roller 24 in rolling contact. Thus, the apparatus 10 can apply a force via the roller 24 in a direction generally towards the mandrel 16 so that the compaction roller 24 exerts pressure on the tape 12 to press it against the mandrel 16 in a compaction region. The roller 24 can also be adjustably mounted by mounts 27, which can adjust relative to the rest of the apparatus 10 so that the roller 24 can steer or otherwise control the placement of the tape 12. While a compaction roller 24 is depicted, other types of compaction devices may be utilized, such as a compaction shoe or a press.

The apparatus 10 is moved relative to the mandrel 16 by a drive assembly 26, which is schematically indicated in FIG. 1. The drive assembly 26 can include various drive devices such as pneumatic or hydraulic actuators, electrical motors or servos, and/or chain, gear, or shaft drive mechanisms. The drive assembly 26 can be configured to move the apparatus 10 or the mandrel 16 to achieve the desired relative placement of the apparatus 10 relative to the mandrel 16 for disposing the tape 12 over the surface 18 of the mandrel 16. Typically, the apparatus 10 is moved generally linearly along the surface 18 of the mandrel 16 in multiple passes, with one or more portions of the tape 12 being disposed in each pass. For example, the apparatus 10 can move from a first end 28 of the mandrel 16 to an opposite end 30 to dispose one or more tape 12, then return to the first end 28 to start another pass in the same direction to dispose additional tape 12 adjacent those tapes 12 disposed in the previous pass. Alternatively, the apparatus 10 can wrap one or more tapes 12 in continuous passes around the mandrel 16, with the position and/or direction being adjusted between each pass so that the tapes 12 are disposed in adjacent portions.

The apparatus 10 can also include various other components. For example, rollers 32, 34 can be used to guide the tape 12 through the apparatus 10. Any number of rollers 32, 34 can be provided, and in some cases, some or all of the rollers 32, 34 can be driven by a motor or other actuator to control the motion of the tape 12. A detector 80, such as a camera or photo eye, can detect the profile and location of the tapes 12 on the mandrel 16 to verify that the tapes are properly configured, e.g., with minimum gaps and laps. In addition, the apparatus 10 typically includes a heating device 36 for heating the tape 12 and/or the mandrel 16. The heating device 36 can be a laser, a laser diode array, a hot gas torch, an electric heater, or the like. The heating device 36 typically delivers sufficient energy to permit the tape 12, once subjected to the compaction forces, to adhere to the underlying tape 12.

The heating device 36 can include multiple independent heating elements, such as multiple laser diodes that form an array. Each heating element can be coupled to a power source in a manner independent of the other laser diodes so that the operating power of each heating element can be controlled independently of the other heating elements. One such heating device is further described in U.S. Pat. No. 6,451,152, which is incorporated by reference. Further, as described in U.S. Pat. No. 6,451,152, the individual heating elements can be arranged so that each is configured to heat a particular area or zone, which can be defined by the tape 12, before and/or after being disposed on the mandrel 16. Thus, by altering the operating power of one or more of the heating elements, the heating of a particular one of the tapes 12 or a particular area of the tapes 12 can be controlled independently of the heating of other tapes 12. Non-uniform heating of the zones may be desirable, for example, if the tapes 12 are not the same size or are not made of the same materials and thus require different amounts of energy to attain their optimum temperature for placement. Also, different amounts of heating may be desirable due to the geometry of the mandrel 16. For example, if the apparatus 10 is placing tape 12 along a curved path, the tapes being placed on the outside of the curve will follow a curve of greater radius and will be placed at a faster rate than the tapes on the inside of the curve. Thus, those tapes on the outside of the curve may require more heating than the tapes on the inside of the curve.

The heating device 36 can electrically communicate with a controller 40 configured to control the heating device 36. The controller 40 can also perform other functions, for example, functions integral to inspection, speed control, temperature and velocity sensing, defect marking, and the like. For example, the apparatus 10 can have an inspection system 42 that includes cameras, temperature sensors, pre-placement detectors, tack monitoring devices, and the like for monitoring the tape 12. Additionally, the apparatus 10 can include a marking device for marking defects or other designated portions of the composite member 14.

Further, the apparatus 10 includes a trimmer 50 configured to trim the tape 12 to a desired configuration. As shown in FIG. 1, the trimmer 50 includes a mechanical cutting device such as a blade 52 defining a sharp edge 54. A reciprocating actuator 56 can be provided for moving the blade 52 in alternating directions, generally perpendicular to the plane of the tape 12, so that the blade edge 54 can be used to cut smoothly through the tape 12. The blade 52 can be moved at an ultrasonic speed, i.e., about 20,000 Hz or above. Alternatively, the trimmer 50 can include other cutting devices such as a roller defining a sharp circumferential edge, a stationary blade, a laser, or the like. In any case, the actuator 56 can also be configured to move the blade 52 or other cutting device in directions transverse to the length of the tape 12 to adjust the amount of tape 12 to be trimmed. Further, the actuator 56 can be configured to adjust the angle of the blade 52 relative to the tape 12, e.g., to optimize the cutting operation of the blade 52. One or more collector devices 58 can be provided for receiving a trimmed portion 13 of the tape 12, which can be discarded or re-used.

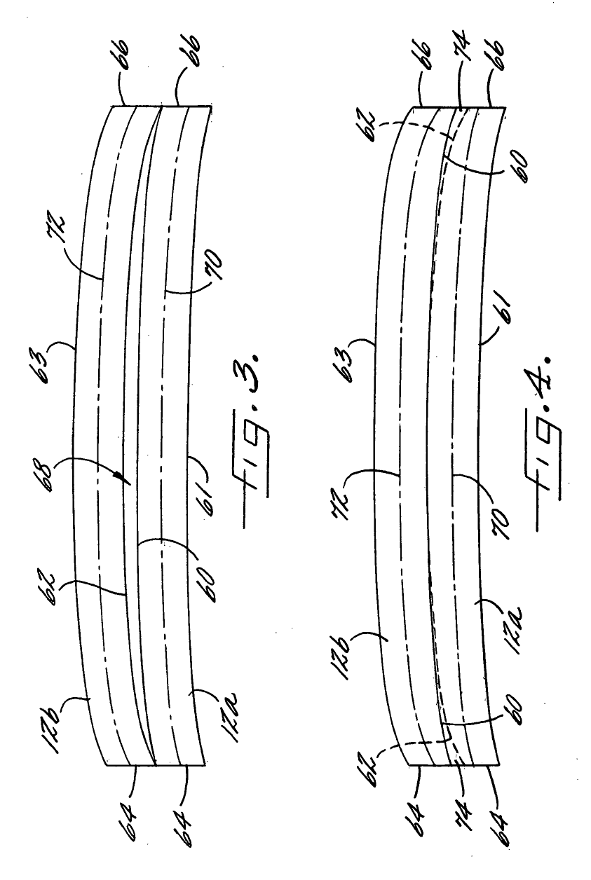

The trimmer 50 can be used to trim some or all of the tapes 12 to reduce or eliminate the occurrence of overlapping of adjacent tapes 12 and the occurrence of spaces between the adjacent tapes 12, i.e., laps and gaps between the adjacent tapes. In this regard, FIG. 3 illustrates two of the elongate rectangular tapes, referred to by reference numerals 12a and 12b, respectively. The tapes 12a, 12b are disposed adjacently, each tape 12a, 12b defining a curved configuration corresponding to an exemplary contour of a structural member. The centerline 70, 72 of each tape 12a, 12b is indicated for illustrative clarity. As illustrated, with the tapes 12a, 12b disposed according to the desired contour, side edges 60, 62 of the tapes 12a, 12b do not correspond. That is, if longitudinal ends 64, 66 of the tapes 12a, 12b are disposed in contact, as shown, the side edges 60, 62 of the two tapes 12a, 12b define a gap 68. In this case, the gap 68 defines a maximum at a longitudinal midpoint of the tapes 12a, 12b. As shown in FIG. 4, if the tapes 12a, 12b are disposed similarly but with the centerlines 70, 72 of the tapes 12a, 12b closer together so that the side edges 60, 62 are in contact at their midpoints, the tapes 12a, 12b overlap, with the amount of overlapping portions 74 increasing in a direction from the midpoint toward each of the ends 64, 66 of the tapes 12a, 12b. Such gaps 68 or laps 74 can adversely affect the strength or other properties of the resulting composite member 14.

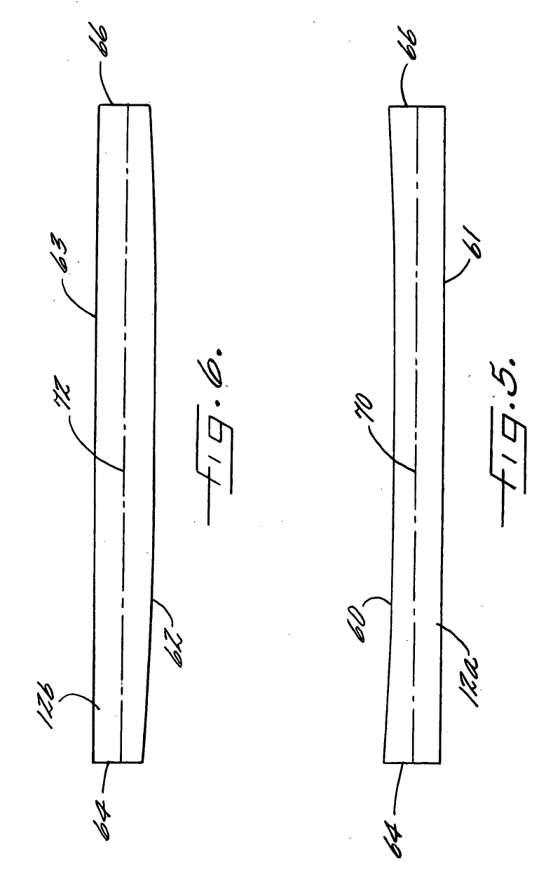

FIGS. 5 and 6 illustrate the tapes 12a, 12b, which have been trimmed so that the tapes 12a, 12b can be disposed substantially without gaps or laps. By the term “substantially without gaps or laps,” it is generally meant that the adjacent tapes do not define gapping or overlapping portions that are more than a predetermined maximum width (measured in the transverse direction of the tapes). For example, the adjacent tapes can be disposed without overlapping and with gaps that are between about 0 and 0.002 inch. The tapes 12a, 12b are shown in a planar configuration for illustrative clarity, but the tapes 12a, 12b can be disposed in a curved configuration, e.g., according to the same contour shown in FIGS. 3 and 4. One of the side edges 60, 62 of each of the tapes 12a, 12b of FIGS. 5 and 6 has been trimmed so that each tape 12a, 12b can be disposed adjacent a rectangular tape substantially without gaps or laps. In particular, the side edge 60 of the first tape 12a illustrated in FIG. 5 has been trimmed to be nonparallel to an opposite side edge 61 of the first tape 12a. The side edge 60 defines a nonlinear profile and, in particular, a concave profile. As shown in FIG. 6, the side edge 62 of the second tape 12b has been trimmed to be nonparallel to an opposite side edge 63 of the second tape 12b and, in particular, to a nonlinear profile defining a convex curve. Thus, either of the tapes 12a, 12b can be disposed with a rectangular (untrimmed) tape without defining any substantial gaps or laps. Alternatively, the corresponding side edges 60, 62 of both of the adjacent tapes 12a, 12b can be trimmed, typically to a lesser extent than if only one of the tapes 12a, 12b is trimmed. Typically, a trimmed edge is disposed adjacent to an untrimmed edge, i.e., only one of each pair of adjacent edges is trimmed.

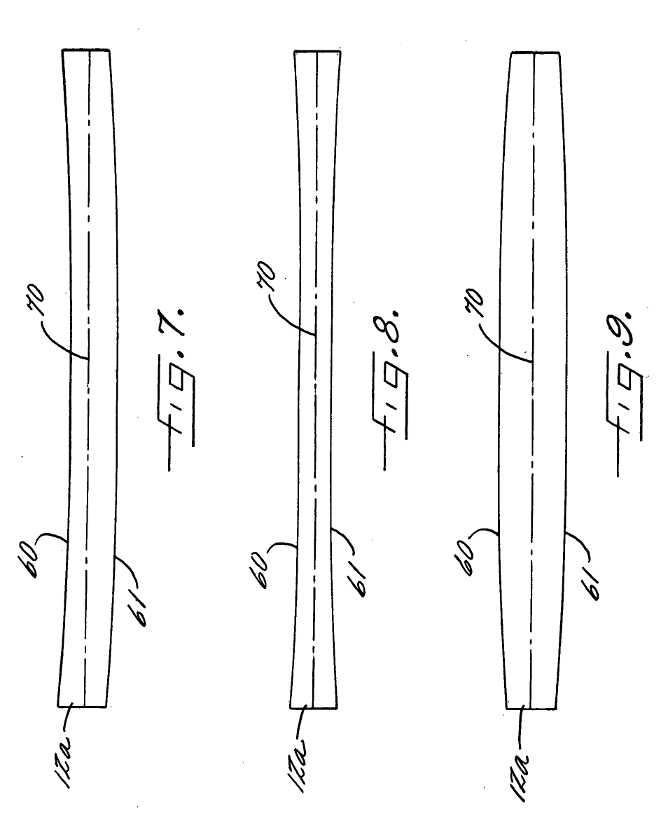

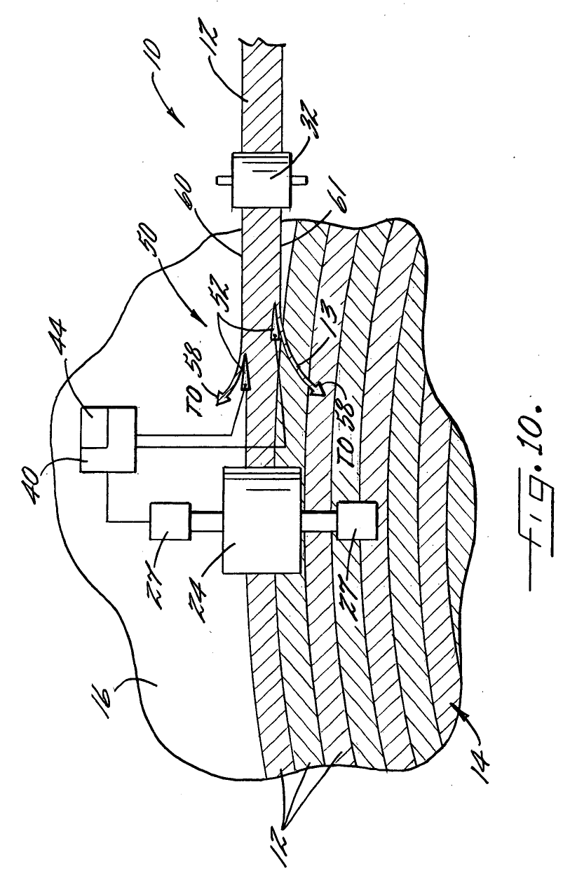

Although only one edge of each tape is typically trimmed, in some cases both side edges 60, 61 of a single one of the tapes 12a can be trimmed, as shown in FIGS. 7-9. One edge 60 can be trimmed to a concave profile and the opposite edge 61 can be trimmed to a convex profile (FIG. 7); both edges 60, 61 can be trimmed to concave profiles (FIG. 8); or both edges 60, 61 can be trimmed to convex profiles (FIG. 9). In fact, one or both of the edges 60, 61 can be trimmed to any profile to correspond to the shape of an adjacent edge of an adjacent tape. For example, the first side edge 60 of the tape 12a can be trimmed to correspond to the profile of a second tape adjacent the first edge 60, and the second side edge 61 of the tape 12a can be trimmed to correspond to the profile of a third tape adjacent the second edge 61. In some cases, the tapes 12 can be trimmed to define irregular shapes having nonuniform curvature, linear portions, angles, and the like. Typically, at least some of the tapes 12 are disposed without being trimmed, while a plurality of the tapes 12 are trimmed to correspond so that the occurrence of gapping or lapping between the tapes 12 is reduced or substantially eliminated.

The trimming operation is typically performed as a substantially separate operation from the layup of the composite member 14. That is, the trimmer 50 can be used to trim the tape 12 to a predetermined configuration, and the tape 12 can be used (or stored and then used) for a subsequent layup. In this regard, the trimmer 50 can be provided separately from the rest of the apparatus 10 so that the trimming and layup can be performed at substantially separate times and/or separate locations. The tape 12 can then be disposed using various layup devices, including conventional tape laying machines such as those used for laying up one-piece fuselages. One-piece fuselages and tape laying machines are further described in U.S. patent application Ser. Nos. 10/646,509, filed Aug. 22, 2003; 10/646,392, filed Aug. 22, 2003; 10/630,594, filed Jul. 28, 2003; 10/646,316, filed Aug. 22, 2003; 10/717,030, filed Nov. 18, 2003; 11/001,803, filed Dec. 2, 2004; 11/048,390, filed Feb. 1, 2005; 11/005,667, Dec. 7, 2004; 11/055,975, filed Jan. 14, 2005; 10/853,075, filed May 25, 2004; 10/851,381, filed May 20, 2004; 10/899,660, filed Jul. 26, 2004; 10/949,848, filed Sep. 23, 2004; and 10/996,922, filed Nov. 24, 2004, which are incorporated by reference. Conventional tape laying machines can be adapted to automatically move to precise locations and angles and along precise routes of travel, e.g., according to numeric coordinate values. The mandrel can be provided in a known reference position relative to the tape laying machine so that the machine can dispose the tapes at the desired locations and in the desired configuration on the mandrel.

In order to determine the desired shape of the tapes 12, and hence the trimming to be performed, the desired contour of the composite member 14 can be modeled or otherwise determined or predicted mathematically and/or geometrically. That is, equations or positional data points can be calculated or otherwise developed to describe the contour of the composite member 14, including the configuration of each tape 12. Various methods can be used for predetermining the shape of the tapes 12. For example, according to one method, a model surface corresponding to one of the surfaces of the composite member 14 can first be developed. The model surface can be the same as the surface 18 of the mandrel 16. Thereafter, the configuration of a first one of the tapes 12a is determined, with the tape 12a disposed on the model surface. For example, equations or data points corresponding to the first side edge 60 of the first tape 12a are determined, to describe the first side edge 60 with the tape 12a disposed on the model surface. A configuration of a second tape 12b is determined, with the second tape 12b also disposed on the model surface, and the side edge 62 of the second tape 12b disposed against the first side edge 60 of the first tape 12a. If the first and second tapes 12a, 12b cannot be disposed without a lap or gap being defined, the amount and location of the overlap is determined so that a corresponding amount of material can be removed from the second tape 12b by trimming. Data or instructions describing the amount and dimensions of the material to be removed can be stored so that the trimmer 50 can be controlled accordingly. For example, the data can be communicated to a memory 44 of the controller 40 and stored in the memory 44. Similarly, the configuration of additional tapes 12, and the corresponding data for trimming those tapes 12, can be determined. In some cases, a small overlap or a small gap between some or all of the tapes 12 may be acceptable or even preferable, and trimming might not be required to eliminate such small overlaps or gaps. For example, a conventional tape with a “nominal” width of 6 inches typically has an actual width that is between about 5.970 and 6 inches. Such tapes can be disposed adjacently with a gap of, e.g., about 0.020 inch or less.

The trimming operation can be controlled by a computer software program, i.e., instructions provided to a controller or other processor that controls the trimming operation. The software estimates the existing gaps between tape courses and adjusts a tape course so that the largest gap between two tape courses is within an allowable gap limit. The overlapping material is then trimmed or profiled off such that the gaps between the tapes courses are within acceptable tolerances. In addition, the placement of the tapes can be adjusted to improve the fit of the adjacent tapes. Methods and algorithms for such software are further described in copending U.S. patent application Ser. No. 60/615,895.

FIG. 10 illustrates a portion of the apparatus 10 during formation of the composite member 14. The trimming and layup of the tapes 12 is shown in FIG. 10 as a combined operation. That is, the tape 12 is trimmed substantially immediately before being disposed onto the mandrel 16. As illustrated in FIG. 10, the trimmer 50 can include a knife or other blade 52 for trimming the tape 12. Typically, only one side of the tape 12 is trimmed, but in some cases multiple blades can be used to trim both of the side edges 60, 61 of the tape 12. Thus, either of the side edges 60, 61 can be trimmed to correspond to the profile of an adjacent tape 12 that is disposed on the mandrel 16 or that is to be disposed on the mandrel 16.

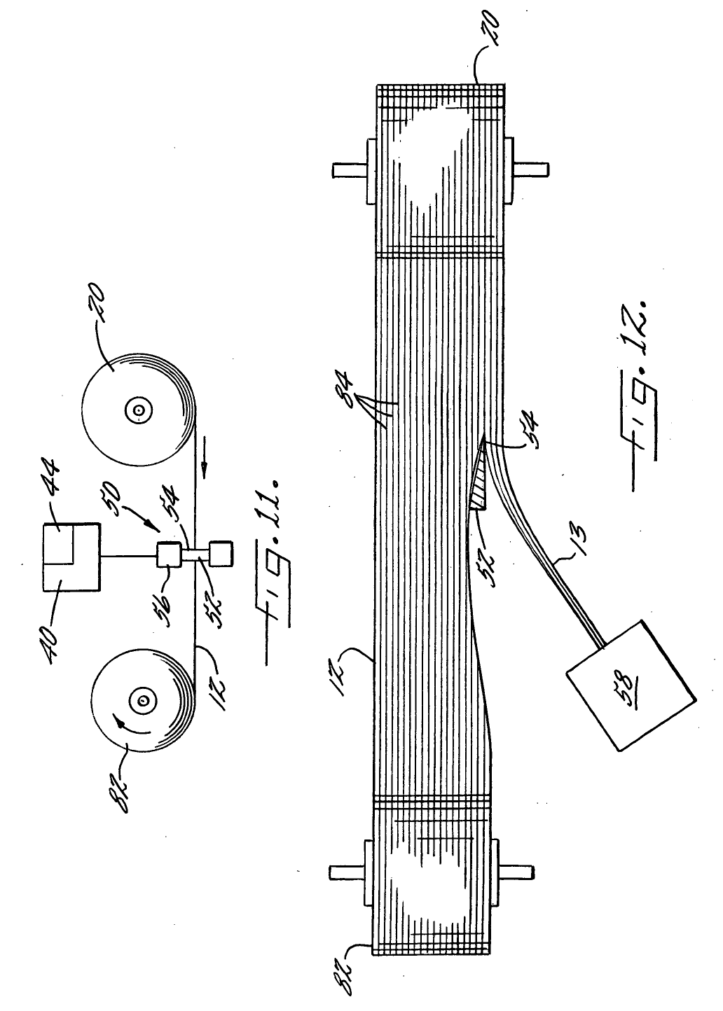

Alternatively, the trimming and layup operations can be performed separately, and the tapes 12 can be rolled or otherwise stored between operations. That is, if the profile of one or more tapes 12 is predetermined before being disposed on the mandrel 16, the tape(s) 12 can be stored so that each tape 12 can be accurately dispensed during a subsequent layup operation. For example, as shown in FIGS. 11 and 12, the tape 12 can be dispensed from the roll 20, trimmed by the trimmer 50, and wound onto a second roll 82 or otherwise disposed in a second supply device so that the tape 12 can be subsequently dispensed onto the mandrel 16 in the predetermined configuration. In either case, the tape 12 can be dispensed from the roll 20 or another supply device to the trimmer 50.

The trimmer 50 is typically used to cut only partially through the tape 12 in the transverse direction. That is, each tape 12 is not typically severed transversely between the side edges by the trimmer 50. However, as illustrated in FIG. 12, the trimmer 50 can cut partially transversely through the tape 12 and, in particular, sufficiently far in the transverse direction such that one or more of the reinforcement members 84 provided in the tape 12 is severed. Thus, after trimming, some of the reinforcement members 84 can extend only partially between the ends 64, 66 of the tape 12. Further, some reinforcement members 84 can be trimmed to define multiple disconnected portions, e.g., by removing a portion of each reinforcement member 84 between the ends 64, 66 of the tape 12 so that the remaining portions of the reinforcement member 84 extend partially from each end 64, 66 inward toward the opposite end 64, 66.

The invention is not limited to the specific disclosed embodiments. Although specific terms are employed, they are used in a generic and descriptive sense only and not for purposes of limitation.

That which is claimed:

1. A method for forming a composite member using automated tape laying machines, comprising the steps of:
applying a first tape along a mandrel having a contoured forming surface with a tape laying machine in accordance with a product definition; and
applying a second tape next to the first tape while adjusting the path of the tape laying machine to eliminate overlap of the first and second tapes and to maintain an acceptable gap between abutting edges of the tapes in accordance with the product definition.

2. A method according to claim 1, further comprising slitting at least one tape along at least one edge to better fit the tape to the contoured forming surface by reducing the width of the tape in selected locations.

3. A method according to claim 2 wherein the slitting step comprises trimming a side edge of one of the tapes to a nonlinear configuration.

4. A method according to claim 2 wherein the slitting step comprises trimming at least one side edge of a plurality of the tapes.

5. A method according to claim 2 wherein the slitting step comprises trimming the tape with a blade edge.

6. A method according to claim 5 wherein the slitting step comprises ultrasonically reciprocating the blade edge to cut the tape.

7. A method according to claim 2 wherein the slitting step comprises determining the configuration of the tapes before the tapes are disposed on the surface.

8. A method according to claim 7, further comprising storing the tapes between the slitting and applying steps in a supply device.

9. A method according to claim 7 wherein the determining step comprises mathematically modeling the configuration of the tapes.

10. A method according to claim 2 wherein the slitting step comprises cutting only some of the reinforcement members of the tape.

11. A method according to claim 2 wherein the slitting step comprises trimming the tape to define a continuous arc.

12. A method according to claim 2 wherein the slitting and disposing steps comprise disposing the tapes on the surface with substantially no laps or gaps therebetween.

13. A composite member defining a contour surface, the member comprising:
a plurality of elongate tapes disposed in a substantially parallel configuration on the contour surface according to a product definition, each tape including a plurality of reinforcement members disposed in a matrix material,
wherein each elongate tape defines first and second side edges, the first side edge of a first one of the tapes defining a nonparallel configuration relative to the second edge of the first tape such that the first side edge of the first tape corresponds to a configuration of a second one of the tapes disposed adjacent to the first edge of the first tape to eliminate overlap of the first and second tapes and to maintain an acceptable gap between abutting edges of the tapes in accordance with the product definition.

14. A composite member according to claim 13 wherein the first edge of the first tape defines a nonlinear configuration.

15. A composite member according to claim 13 wherein the second edge of the first tape defines a nonlinear configuration corresponding to a configuration of a third one of the tapes disposed adjacent the second edge of the first tape.

16. A composite member according to claim 13 wherein each of at least two of the tapes defines nonparallel side edges that correspond to adjacent tapes.

17. A composite member according to claim 13 wherein at least one of the reinforcement members of the first tape is noncontinuous between the ends of the tape.

18. A composite member according to claim 13 wherein the first edge of the first tape defines a continuous arc.

19. A composite member according to claim 13 wherein the first edge of the first tape is disposed proximate the second tape with substantially no lap or gap therebetween.

20. An apparatus for disposing elongate tapes during formation of a composite member, the apparatus comprising:
a tape dispenser configured to store at least one elongate tape such that the tape can be dispensed therefrom;
a tape trimmer adapted to receive the tape from the tape dispenser and trim a first side edge of the tape; and
a controller configured to control the tape trimmer and thereby trim the tape to define a profile corresponding to an adjacent tape of the composite member.

21. An apparatus according to claim 20, further comprising a placement guide configured to dispose the tape on a contour surface in a shape corresponding to a desired contour of the composite member.

22. An apparatus according to claim 20, further comprising a roll configured to receive the trimmed tape from the tape trimmer.

23. An apparatus according to claim 20 wherein the tape trimmer is configured to trim the first side edge of the tape to a nonlinear configuration.

24. An apparatus according to claim 20 wherein the tape trimmer is configured to trim a second side edge of the tape opposite the first side edge.

25. An apparatus according to claim 20 wherein the tape trimmer comprises an ultrasonic blade configured to reciprocate and thereby cut the tape.

26. An apparatus according to claim 20, further comprising a detector for detecting a contour defined by the composite member and communicating with the controller.

27. An apparatus according to claim 20, further comprising a memory configured to store data for trimming the tape according to a predetermined configuration.
